(19) United States
(12) Patent Application Publication
(10) Pub. No.: US 2012/0130720 A1
(43) Pub. Date: May 24, 2012

(54) INFORMATION PROVIDING DEVICE

(75) Inventor: Yasushi Suda, Kasugai (JP)

(73) Assignee: ELMO COMPANY LIMITED, Nagoya (JP)

(21) Appl. No.: 13/295,510

(22) Filed: Nov. 14, 2011

(30) Foreign Application Priority Data
Nov. 19, 2010 (JP) 2010-258687

(51) Int. Cl. G10L 21/06

(52) U.S. Cl. 704/276; 704/E21.02

(57) ABSTRACT

An information providing device takes an image of a predetermined area and obtains the taken image in the form of image data, while externally obtaining voice data representing speech. The information providing device obtains text in a preset language corresponding to the speech in the form of text data, based on the obtained voice data, generates a composite image including the taken image and the text in the form of composite image data, based on the image data and the text data, and outputs the composite image data.

### CROSS-REFERENCE TO RELATED APPLICATION

The present application claims priority from Japanese application P2010-258687A filed on Nov. 19, 2010, the contents of which are hereby incorporated by reference into this application.

### BACKGROUND

1. Field of the Invention

The present invention relates to an information providing device.

2. Description of the Related Art

Recently, image providing devices have widely been used for presentations. The known technology relating to the image providing devices includes, for example, the technology disclosed in JP 2010-245690.

When a presentation is made in an environment where the presenter's voice is not readily recognizable, or when some audiences have hearing problems, the audiences may have difficulty in understanding the content of the presenter's speech.

### SUMMARY

Consequently, in order to address the problem described above, there is a need to enable audiences to readily understand the content of speech made by a presenter in a presentation using an information providing device.

In order to achieve at least part of the foregoing, the present invention provides various aspects and embodiments described below. A first aspect of the invention relates to an information providing device comprising an image data acquirer configured to take an image of a predetermined area and obtain the taken image in form of image data; a voice data acquirer configured to externally obtain voice data representing speech; a text data acquirer configured to obtain a text in a preset language corresponding to the speech in form of text data, based on the obtained voice data; an image combiner configured to generate a composite image including the taken image and the text in form of composite image data, based on the image data and the text data; and an output unit configured to output the composite image data to outside.

The information providing device according to the first aspect converts the externally obtained voice data into text data, combines the image data with the text data to generate composite image data and outputs the composite image data to the outside. For example, during a presentation with display of the composite image data on an image display device connected to the information providing device, the information providing device obtains speech (voice) externally collected by a sound collector, such as a microphone, in the form of voice data, converts the voice data into text data, combines the text data with the image data of the taken image to generate composite image data and displays a composite image including the taken image and the text corresponding to the presenter's speech, on the image display device.

A second aspect of the invention relates to the information providing device, wherein the text data acquirer comprises a voice/text converter configured to recognize the obtained voice data and convert the voice data into the text data in the preset language.

In the information providing device according to the second aspect, the text data acquirer includes the voice/text converter and accordingly does not need to externally obtain text data corresponding to voice data. There is thus no need to connect with any external device having voice/text converting function. This ensures acquisition of text data corresponding to voice data by the information providing device alone.

A third aspect of the invention relates to the information providing device, wherein the text data acquirer obtains the text data converted from the voice data via a line.

The information providing device according to the third aspect obtains the text data via the line and does not need to have any processor for the voice/text conversion function, unlike the information providing device of the second aspect.

A fourth aspect of the invention relates to the information providing device, further comprising: a text data storage configured to store the converted text data as file data in a readable manner.

The information providing device according to the fourth aspect stores the text data in the form of readable file data, so that the content of the presenter's speech during a presentation can be utilized later as text data.

A fifth aspect of the invention relates to the information providing device, wherein the text data acquirer obtains a text in a different language from the preset language corresponding to the speech in form of text data, based on the voice data obtained by the voice data acquirer.

The information providing device according to the fifth aspect obtains text data in a different language from the preset language, based on the obtained voice data. Displaying the text data in the different language from the preset language as part of the composite image enables audiences who are not familiar with the preset language but are familiar with the different language to understand the content of the presenter's speech.

A sixth aspect of the invention relates to the information providing device, wherein when an object placed in the predetermined area is changed, the image combiner recognizes the change of the object based on the image data and, once recognizing the change, refrains from combining the text data corresponding to the voice data obtained before the change with image data representing an image of the object taken after the change.

The information providing device according to the sixth aspect refrains from displaying the contents of the presenter's speech in the form of the text with regard to the object before the change during display of the object after the change. This enables audiences to readily understand the correspondence relationship between the video image and the text.

A seventh aspect of the invention relates to the information providing device, wherein when an object placed in the predetermined area is changed, the image combiner recognizes the change of the object based on the image data and, once recognizing the change, uses still image data representing a latest still image of the object taken immediately before the change for image combining with the text data corresponding to the voice data obtained before the change for a predetermined time period to generate the composite image data.

The information providing device according to the seventh aspect displays a composite image generated by combining the text data corresponding to the voice data obtained before change of the object with still image data representing a latest still image of the object taken immediately before the change. Even when the object is changed during the presenter's speech with regard to the object before the change, this enables audiences to watch the text corresponding to the content of the presenter's speech with regard to the object before the change, along with the taken image of the object before the change.

An eighth aspect of the invention relates to the information providing device, wherein the image combiner detects a blank area of the taken image based on the image data and generates composite image data representing a composite image including the text superimposed on the detected blank area of the taken image.

The information providing device according to the eighth aspect sets the area for displaying the text with high efficiency, while maximizing the area for displaying the text to allow for enlarged display of the text in the composite image or display of the larger volume of text in the composite image.

A ninth aspect of the invention relates to the information providing device, wherein the text data acquirer comprises a text data acquisition changeover module configured to change over setting between acquisition or no acquisition of the text data in response to a user's preset operation, and when the text data acquirer is set to no acquisition of the text data by the text data acquisition changeover module, the output unit outputs the image data, in place of the composite image data.

The information providing device according to the ninth aspect enables only the user's (presenter's) desired speech to be input into the information providing device.

A tenth aspect of the invention relates to the information providing device, wherein the image combiner comprises a text display controller configured to control at least one of size of the text to be combined to generate the composite image, font, number of characters on each line, number of lines in the text, color of characters, background color and display time, in response to a user's preset operation.

The information providing device according to the tenth aspect enables, for example, the size of the text to be included in the composite image, the font, the number of characters on each line, the number of lines in the text, the color of characters, the background color or the display time to be controlled in response to the user's preset operation. The text can thus be displayed in the composite image according to the user's desired display method.

An eleventh aspect of the invention relates to the information providing device, further comprising: a word information acquirer configured to obtain information on a word included in the text in a displayable manner via a network, based on the text data representing the text obtained by the text data acquirer.

The information providing device according to the eleventh aspect enables, for example, a word in the text included in the composite image data to be hyperlinked to the information obtained by the word information acquirer. This further helps the audience understand the content of the presentation.

A twelfth aspect of the invention, relates to the information providing device, further comprising: a correlated data storage configured to store the image data correlated to the text data in a readable manner.

The information providing device according to the twelfth aspect stores the image data correlated to the text data in a readable manner. For example, a moving image of a presentation may be stored in the form of moving image data in a specific format that allows for selection of either displaying or hiding the text. When the audience reproduces the moving image data to watch the presentation, the unrequired text may be hidden in the display of the composite image.

The present invention may be implemented by diversity of aspects, for example, an information providing method, an information providing device, a presentation system, an integrated circuit or a computer program for implementing the functions of any of the method, the device and the system and a recording medium in which such a computer program is recorded.

### BRIEF DESCRIPTION OF THE DRAWINGS

FIG. 1 illustrates the configuration of an information providing system:

FIG. 2 is a block diagram illustrating the internal structure of an information providing device included in the information providing system of FIG. 1;

FIG. 3 is a flowchart showing an exemplary flow of a text display process;

FIG. 4 illustrates a taken image corresponding to image data;

FIG. 5 illustrates a composite image corresponding to composite image data;

FIG. 6 illustrates a composite image (a);

FIG. 7 illustrates a composite image (b);

FIG. 8 illustrates a composite image (c);

FIG. 9 illustrates a composite image (d); and

FIG. 10 illustrates a composite image (e).

### DESCRIPTION OF EMBODIMENTS

The invention is described in detail with reference to embodiments.

### A. First Embodiment

(A1) Configuration of Information Providing System

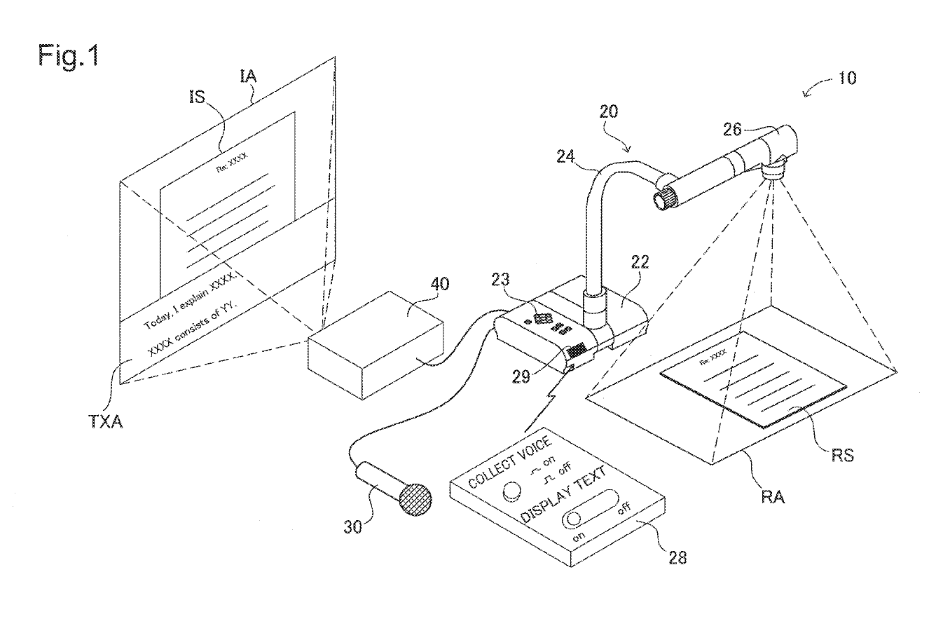

FIG. 1 illustrates the configuration of an information providing system 10 according to one embodiment of the invention. The information providing system 10 includes information providing device 20 and projector 40. The information providing device 20 and projector 40 are interconnected by a cable for data transfer. In the information providing system 10, information providing device 20 takes an image of material RS placed on imaging area RA of information providing device 20, and projector 40 projects and displays the taken image of material RS in projection area IA on a screen. A projected material IS displayed on the screen corresponds to the material RS. A microphone 30 is connected to information providing device 20 to collect external sound, i.e., speech (voice) of a presenter in this embodiment. The voice (sound) collected by microphone 30 is subjected to voice recognition by information providing system 10, and text corresponding to the presenter's speech is projected and displayed in text display area TXA of projection area IA by projector 40.

The information providing device 20 includes main unit 22 placed on, for example, a desk, operation unit 23 provided on main unit 22, support rod 24 extended upward from main unit 22 and camera head 26 attached to an end of support rod 24. The camera head 26 internally has a CCD video camera and takes a moving image of the material RS placed on, for example, the desk at a rate of 30 frames per unit time. The information providing device 20 further includes remote control 28 to make communication by, for example, infrared. The user operates remote control 28 for on/off selection of voice collection (i.e., sound collection) by microphone 30 and on/off selection of display of text corresponding to the speech in text display area TXA.

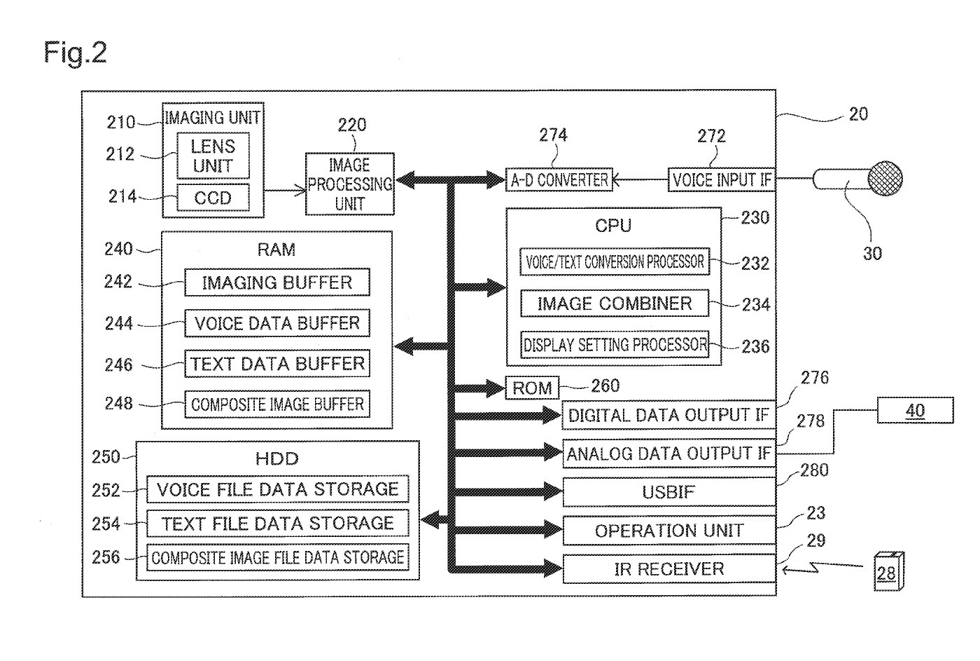

FIG. 2 is a block diagram illustrating the internal structure of the information providing device 20. The information providing device 20 includes imaging unit 210, image processing unit 220, CPU 230, RAM 240, hard disk drive (HDD) 250 and ROM 260. The information providing device 20 also includes audio input interface (audio input IF) 272, digital data output interface (digital data output IF) 276, analog data output interface (analog data output IF) 278, USB interface (USB IF) 280, operation unit 23 and infrared (IR) receiver 29. The imaging unit 210 includes lens unit 212 and charge-coupled device (CCD) 214. The CCD 214 serves as an image sensor to receive light transmitted through lens unit 212 and convert the received light into an electrical signal. The image processing unit 220 includes an AGC (Automatic Gain Control) circuit and a DSP (Digital Signal Processor). The image processing unit 220 inputs the electrical signal from CCD 214 and generates image data. The image data generated by image processing unit 220 is stored in imaging buffer 242 provided in RAM 240.

The audio input IF 272 receives analog voice signals from microphone 30. The analog voice signal received by the audio input IF 272 is converted into digital voice data by analog-to-digital converter (A-D converter) 274. The converted voice data is stored in voice data buffer 244 provided in RAM 240.

The CPU 230 controls the operation of the whole information providing device 20 and loads and executes a program stored in ROM 260 to serve as voice/text conversion processor 232, image combiner 234 and display setting processor 236. The voice/text conversion processor 232 reads and recognizes the voice data stored in voice data buffer 244 and converts the voice data into text data corresponding to English text. The converted text data is stored in text data buffer 246 provided in RAM 240. The voice/text conversion processor 232 may adopt a voice recognition engine, such as AmiVoice (registered trademark) or ViaVoice (registered trademark). This embodiment adopts AmiVoice for voice/text conversion processor 232. In this embodiment, voice/text conversion processor 232 converts English voice data into English text data. According to other embodiments, when the presenter speaks French, for example, voice/text conversion processor 232 may recognize French voice data and convert the voice data into text data corresponding to French text. There are known voice recognition engines for various languages, such as AmiVoice (registered trademark).

The image combiner 234 combines the image data stored in imaging buffer 242 with the text data stored in text data buffer 246 and generates composite image data including the taken image and the text. In other words, the image data is combined with the text data such that the composite image projected and displayed on the screen by projector 40 is the projected image displayed in the projection area IA shown in FIG. 1. The composite image data generated by image combiner 234 is stored in composite image buffer 248 provided in RAM 240. The details of the processing by image combiner 234 will be described later.

In response to the user's instructions via operation unit 23 or remote control 28, the display setting processor 236 controls image enlargement or image size reduction of projected material IS displayed in projection area IA, controls the size of the text to be displayed in the text display area TXA, the font, the number of characters on each line, the number of lines in the text, the color of characters, the background color and the display time in the text display area TXA, and controls selection of either displaying or hiding text display area TXA in projection area IA.

The digital data output IF 276 encodes the composite image data stored in composite image buffer 248 and outputs the encoded composite image data in the form of a digital signal to the outside of information providing device 20. The composite image buffer 248 includes an encoding processor to encode the composite image data. The digital data output IF 276 adopts the USB standard for connection with external devices in this embodiment, but may adopt any other suitable standard for the same purpose, for example, HDMI or Thunderbolt (registered trademark).

The analog data output IF 278 processes the composite image data stored in the composite image buffer 248 by digital-to-analog conversion and outputs the converted analog composite image data in the form of RGB data to the outside of information providing device 20. The analog data output IF 278 includes a D-A converter (DAC). In this embodiment, projector 40 is connected to analog data output IF 278.

The HDD 250 is a large-capacity magnetic disk drive. The HDD 250 includes voice file data storage 252, text file data storage 254 and composite image file data storage 256. The voice file data storage 252 stores the voice data stored in voice data buffer 244 in the form of externally readable file data. The text file data storage 254 stores the text data stored in text data buffer 246 in the form of externally readable file data. The composite image file data storage 256 stores the composite image data stored in composite image buffer 248 in the form of externally readable file data.

(A2) Text Display Process

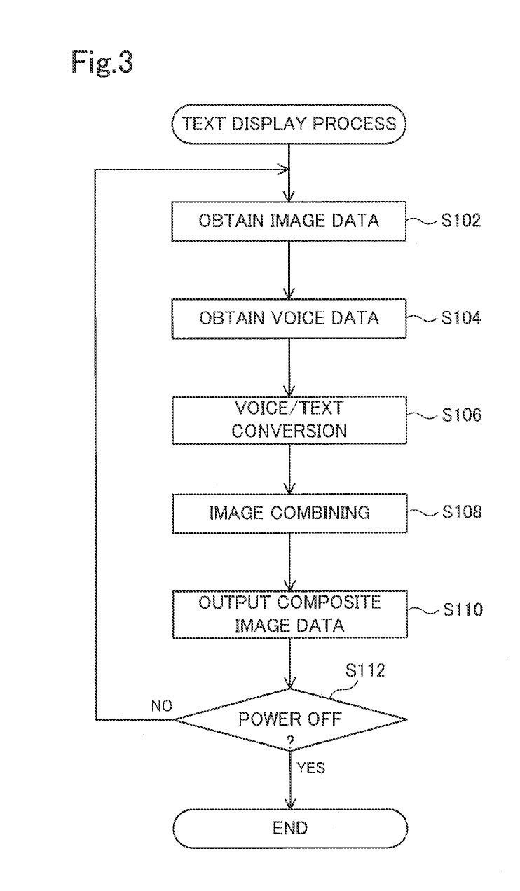

The text display process performed by the information providing system 10 is described below. The text display process displays text corresponding to the speech (voice) collected by microphone 30, along with material RS placed in imaging area RA, in projection area IA. FIG. 3 is a flowchart showing an exemplary flow of text display process. The text display process is triggered by the user's ON operation of the power switch of the information providing device 20 included in operation unit 23. At the start of the text display process, CPU 230 obtains image data generated by imaging unit 210 and image processing unit 220 and stores the obtained image data in imaging buffer 242 (step S102).

The CPU 230 subsequently obtains the presenter's speech (voice) in the form of voice data from microphone 30 via voice input IF 272 and A-D converter 274 and stores the obtained voice data in voice data buffer 244 (step S104). The CPU 230 reads the obtained voice data and activates the voice recognition engine as the function of voice/text conversion processor 232 to convert the voice data into English text data and store the converted text data in text data buffer 246 (step S106). After completion of the voice/text conversion, CPU 230 performs image combining (step S108). More specifically, the procedure of image combining reads out the image data and the text data respectively from imaging buffer 242 and text data buffer 246 and combines the two read data to generate composite image data.

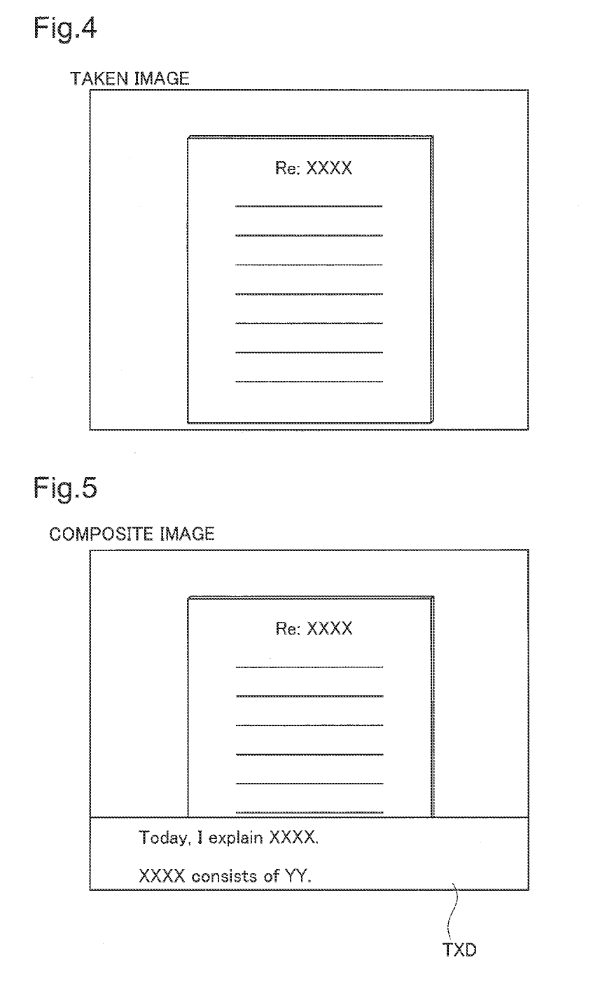

FIG. 4 illustrates the taken image corresponding to the image data. FIG. 5 illustrates the composite image corresponding to the composite image data. The CPU 230 performs the image combining to superimpose the text onto a blank image corresponding to text display area TXA (FIG. 1) to generate image data (text image data TXD). The CPU 230 subsequently superimposes the text image data TXD onto the lower portion of the image data to generate composite image data as shown in FIG. 5. In response to the user's instructions through the operations of operation unit 23, display setting processor 236 controls the display of the text, for example, the font, the size of characters and the color of characters in the text and processes the text. The image combiner 234 then superimposes the text processed by the display setting processor 236 onto the blank image corresponding to text image area TXA to generate text image data TXD, and eventually generates the composite image data. The technology generally used for OSD (On Screen Display) may be utilized for image combining.

After the image combining, CPU 230 stores the generated composite image data in composite image buffer 248 and sequentially outputs the composite image data converted into RGB data to projector 40 via analog data output IF 278 (step S110). The CPU 230 repeats this series of processing (steps S102 to S110) until the user powers OFF information providing device 20 (step S112). When the user operates remote control 28 to give an instruction for hiding the text in projection area IA, CPU 230 outputs the image data stored in imaging buffer 242 instead of the composite image data from the analog data output IF 278 or the digital data output IF 276.

In addition to the text display process, CPU 230 stores the voice data, the text data and the composite image data obtained during the text display process in HDD 250 in the form of readable file data. More specifically, CPU 230 respectively stores the voice file data, the text file data and the composite image file data into voice file data storage 252, text file data storage 254, and composite image file data storage 256. For example, CPU 230 may store the voice data file in a suitable format for voice files, such as WMA, MP3 or AAC, the text file data in a suitable format for text files, such as TXT or DOC, and the composite image file data in a suitable format for moving images or still images, such as MPG, AVI or WMV, into HDD 250. In this embodiment, these file data are stored in a readable manner to be read out to a computer, a hard disk drive or a storage device such as SSD (Solid State Drive) connected via the USB IF 280.

According to this embodiment, a voice signal is received from microphone 30 connected to voice input IF 272. According to another embodiment, a voice signal may be received from any suitable sound (voice) output device, for example, MP3 player, iPod (registered trademark), tape recorder or MD player, connected to the voice input IF 272. In the information providing device 20 of the embodiment, composite image data is output to projector 40, and projector 40 projects and displays a composite image onto the screen. According to another embodiment, composite image data may be output to a television set connected to digital data output IF 276 or analog data output IF 278 or to an image display device, such as a display connected to the computer, and the television set or the image display device may display a composite image. According to still another embodiment, a speaker may be connected to a voice output interface of the information providing device 20, and the voice signal received via the voice input IF 272 may be output in the form of voice from the speaker.

According to one embodiment, when the object (material RS) placed in imaging area RA is changed, information providing device 20 may detect the change and refrain from combining the text data corresponding to the voice data obtained before the change with new image data after the change. More specifically, during the image combining by image combiner 234, CPU 230 continually detects a variation in brightness of the image data as the image combining subject. When a variation in brightness over a preset level is detected in a predetermined area or greater area of the image data, CPU 230 determines that material RS placed in imaging area RA (FIG. 1) has changed. Even when it is supposed to continuously display the text after voice/text conversion in text display area TXA for at least a predetermined time period, CPU 230 upon detecting a change of the material RS, may immediately hide the display of the text data obtained before the detection of the change of material RS, irrespective of no elapse of the predetermined time period. The CPU 230 may then refrain from displaying the text data with regard to the material RS (before the change) to the image of the new material RS (after the change) is projected and displayed in the projection area IA. The CPU 230 detects a change of the material RS based on the image data and, once detecting the change, refrains from combining the text data corresponding to the voice data obtained before the change of the material RS with the image data of the new material RS (after the change).

According to another embodiment, when detecting a change of the material RS, CPU 230 may combine the text data corresponding to the voice data obtained before the change of the material RS with still image data representing a latest still image of the material RS taken immediately before the change. The still image data may be used continuously for the image combining, until display of all the text data corresponding to the voice data obtained before the change of the material RS is completed. This procedure maintains the correspondence relationship between the image data of a material and the text data obtained by speech recognition of the voice data for the material.

As described above, the information providing system 10 of the embodiment recognizes the speech (voice) of the presenter and displays the recognized speech in the form of text in text display area TXA of projection area IA. For example, when a presentation is made in the environment that the presenter's voice is not readily recognizable, when some audiences have hearing problem, or when some audiences are non-native speakers of the language used by the presenter, information providing system 10 enables the audience to readily understand the presenter's speech by reading the text displayed in text display area TXA. When technical terms or academic terms used in a presentation are alien to or unfamiliar to some audiences, the display of text including such terms helps the audiences understand the meaning of the terms. When the text is written in Japanese, for example, the display of text including a technical term coined from the combination of Chinese characters helps the audiences understand the term.

The CPU 230 respectively stores the voice file data, the text file data and the composite image data file in a readable manner in voice file data storage 252, text file data storage 254, and composite image file data storage 256 of HDD 250. Such storage enables any person who has not attended a presentation made by the presenter to watch the presentation by browsing or reproducing the respective file data.

When the information providing device 20 is used to display an image on an image display device, such as projector 40, a computer for preset computing and arithmetic processing is generally provided between information providing device 20 and the image display device. The information providing system 10 of the embodiment, however, does not need the computer for this purpose. The user can thus readily make a presentation by using information providing device 20.

### B. Modifications

The invention is not limited to the above embodiment, but various modifications including modified examples described below may be made to the embodiment without departing from the scope of the invention. Some of possible modifications are given below.

(B1) Modification 1

In the above embodiment, information providing device 20 includes voice/text conversion processor 232 (for example, AmiVoice or ViaVoice) as the voice recognition engine, and CPU 230 performs conversion of voice data into text data. According to one modified example, the information providing device 20 is configured to be connectable to a network and may send voice data to a server or a computer on the network to be subjected to voice/text conversion by a voice recognition engine included in the server or the computer and obtain the converted text data from the server or the computer via the network. According to another modified example, the information providing device 20 may be connected directly to a computer including a voice recognition engine via a signal line, such as a USB cable or a LAN cable. The information providing device 20 may send voice data to the computer to be subjected to voice/text conversion by the voice recognition engine of the computer and obtain the converted text data from the computer via the signal line. In these modified examples, the information providing device 20 is not required to include voice/text conversion processor 232 (voice recognition engine). Using the voice recognition engine on the network enables the information providing device 20 to obtain text data converted by the latest voice recognition engine. This improves the conversion accuracy from voice data to text data.

(B2) Modification 2

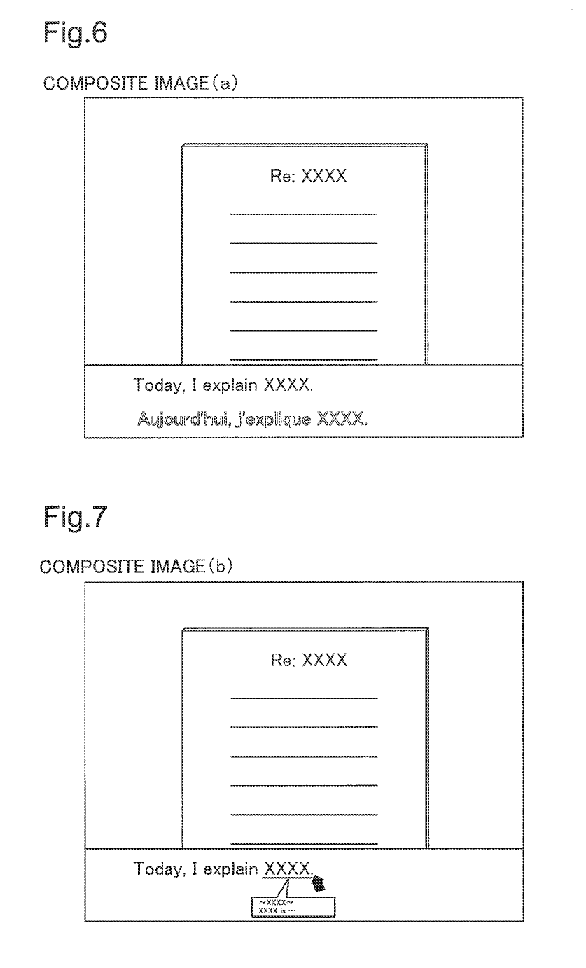

The text display process of the above embodiment converts voice data in a certain language (English in the above embodiment) into text data in the same language and displays only the converted text data in the certain language in text display area TXA. According to one modified example, text in a different language (hereinafter called “different language text”) translated from the converted text data may be displayed, in addition to the text in the certain language. More specifically, the information providing device 20 may include a translation engine, for example, a translation engine adopted for Google translation (Google: registered trademark) or adopted for Excite translation (Excite: registered trademark). The information providing device 20 may obtain text data representing a text translated in a different language (for example, French, Japanese, Chinese, Spanish, Portuguese, Hindi, Russian, German, Arabic or Korean) from the certain language, based on the text data in the certain language (for example, English) stored in text data buffer 246 and display the different language text, along with or independently of the text in the certain language, in text display area TXA as a composite image (a) as shown in FIG. 6.

According to another modified example, information providing device 20 is configured to be connectable to a network and may send text data in a certain language to a server or a computer on the network to be subjected to translation by a translation engine included in the server or the computer and obtain the translated different language text data from the server or the computer via the network. According to still another modified example, information providing device 20 may be connected directly to a computer including a translation engine via a line, such as a USB cable or a LAN cable. The information providing device 20 may send text data in a certain language to the computer to be subjected to translation by the translation engine of the computer and obtain the translated different language text data from the computer via the signal line. According to another modified example, the field of a presentation (e.g., medicine, politics and economy, engineering or social science) may be set in advance in the information providing device 20 by the user. A translation engine specialized for the set field may be selectively used among a plurality of translation engines for multiple different fields in the information providing device 20 or on the network. This enables audiences of various nations, regions and races to understand the content of one identical presentation. Using the translation engine on the network enables the information providing device 20 to obtain different language text data translated by the latest translation engine. This improves the translation accuracy.

(B3) Modification 3

In one embodiment, the audience sees the composite image displayed by projector 40. According to one modified example, the audience may see the composite image using a computer or a digital terrestrial television connected to the information providing device 20 via a line (e.g., network). Each keyword included in the text displayed in text display area TXA may be hyperlinked to a homepage on the network including description of the keyword, e.g., Wikipedia (registered trademark) homepage. This enables the audience to obtain information on the keyword. Like composite image (b) shown in FIG. 7, the hyperlinked keyword may be underlined. During a presentation using a computer display, when the audience places the cursor on the underlined keyword with a pointing device (for example, mouse), information on the keyword may be displayed by pop-up. This further helps the audience understand the content of the presentation.

(B4) Modification 4

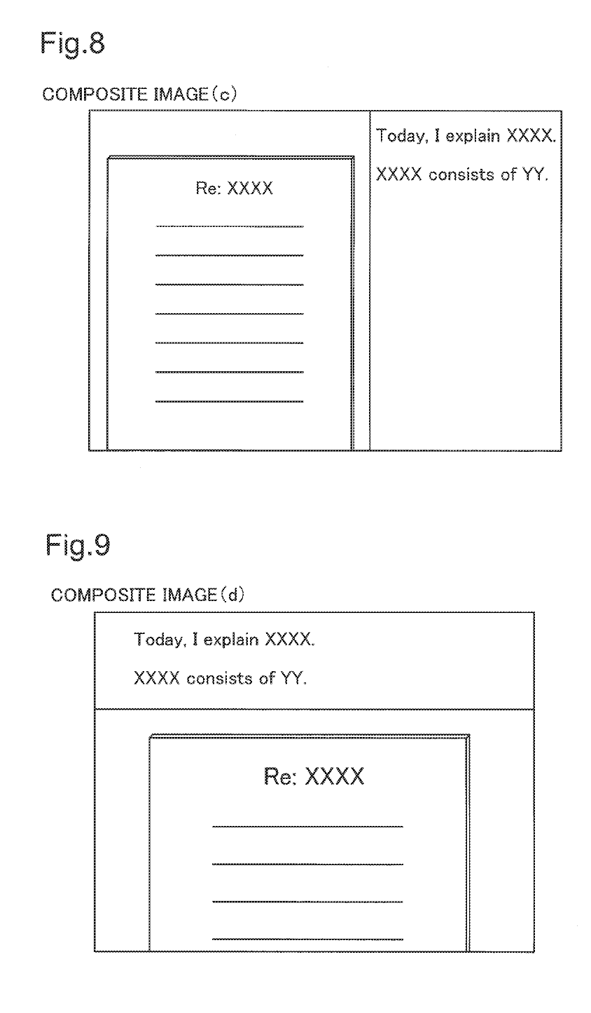

In the above embodiment, CPU 230 generates the composite image including the text located below the taken image by the image combining (FIGS. 4 and 5). This layout is, however, not restrictive but is only illustrative. Like composite image (c) shown in FIG. 8, or composite image (d) shown in FIG. 9, a composite image may be generated, such that text is located in any area of the taken image other than the area actually occupied by the image of the object (material RS in the above embodiment) (hereinafter called “blank area”). More specifically, CPU 230 may detect the blank area by labeling the image data during image processing. The image data may be binarized by preset brightness as a reference value. The same numerical value is allocated to continuous pixels of or over the preset brightness, so as to make the blank area recognizable. This sets the text display area with high efficiency, while maximizing the text display area to allow for enlarged display of text or display of the larger volume of text.

(B5) Modification 5

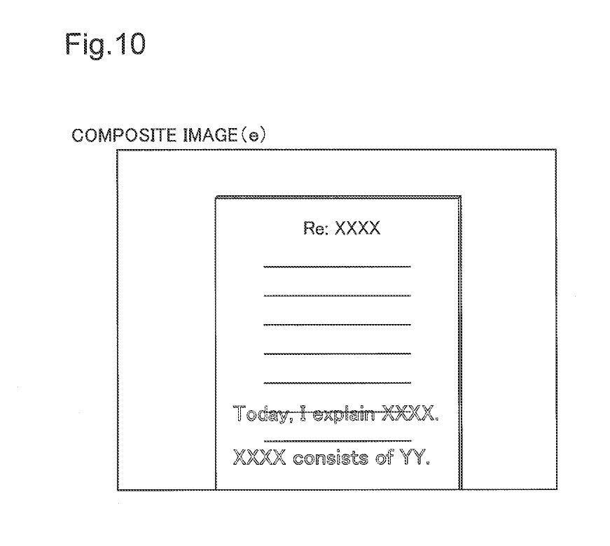

In the above embodiment, the image combining superimposes the text onto the blank image corresponding to text display area TXA (FIG. 1) to generate text image data TXD, and subsequently superimposes text image data TXD onto the image data to generate composite image data. This procedure is, however, not restrictive. Like composite image (e) shown in FIG. 10, composite image data may be generated by directly superimposing a text on the taken image. The shadow effect or frame line may be added to the text. Such modifications ensure advantageous effects similar to those of the above embodiment.

(B6) Modification 6

In the above embodiment, CPU 230 stores the voice file data, the text file data and the composite image file data in HDD 250. The file data are, however, not restricted to this example. According to one modified example, moving image file data including text data correlated to moving image data over time may be generated and stored in HDD 250 in a readable manner. More specifically, moving image file data may be generated in a moving image format that allows for selection of either displaying or hiding the text during reproduction of the moving image and stored in HDD 250. The HDD 250 storing the moving image file data corresponds to the correlated data storage of the invention. Generating such moving image file data enables the audience to hide the text when not required, while ensuring the advantageous effects of the above embodiment. The moving image file data may be written in a recording medium, such as DVD or Blu-ray disc, for distribution.

(B7) Modification 7

The above embodiment uses the voice recognition engine for voice recognition. The latest voice recognition engine having a high voice recognition rate uses a language model, such as n-gram. In this case, co-occurring information is set in advance in respective words. A text included in the image of a material taken with a video camera is recognized by OCR technology, and a word group is obtained from the recognized text. The word group is then provided to the voice recognition engine prior to voice recognition. The voice recognition engine assumes the provided word group as recognized word group and causes relevant word groups having high potential for co-occurrence with the recognized word group to be readily recognizable. This prevents a decrease in the voice recognition rate at the beginning of speech by the presenter and increases the overall voice recognition rate. When context-free grammar is adopted for the language model, the context may be specified by the provided word group. In the case of Japanese text, for example, the text recognized by OCR technology may be converted into a word group by morphology analysis.

In a general presentation, the text included in the material is strongly correlated to the presenter's speech and frequently includes a word group typically used in the field of the speech. Every time the object (material) placed in imaging area RA is changed, one preferable procedure may thus recognize text included in the changed material by OCR technology, obtain a word group from the recognized text (in the case of Japanese text, the recognized text is converted to a word group by morphology analysis), and provide the word group to the voice recognition engine. This constantly increases the voice recognition rate.

In both acoustic models and language models, in order to increase the voice recognition rate, the presenter often provides a specialized dictionary for a highly specialized field, for example, medicine or art, and specifies the field prior to voice recognition in order to manually change the settings of the voice recognition engine (including the setting of the dictionary to be used for voice recognition). This modified example, however, obtains a word group from the recognized text included in the material and provides the word group to the voice recognition engine. This does not require the presenter to specify the field of the speech and manually change the settings of the voice recognition engine, thus improving the usability of voice recognition.

(B8) Modification 8

Part of the functions implemented by the software configuration in the above embodiment may be implemented by hardware configuration, whilst part of the functions implemented by the hardware configuration in the above embodiment may be implemented by software configuration.

What is claimed is:

1. An information providing device, comprising:
an image data acquirer configured to take an image of a predetermined area and obtain the taken image in form of image data;
a voice data acquirer configured to externally obtain voice data representing speech;
a text data acquirer configured to obtain a text in a preset language corresponding to the speech in form of text data, based on the obtained voice data;
an image combiner configured to generate a composite image including the taken image and the text in form of composite image data, based on the image data and the text data; and
an output unit configured to output the composite image data.

2. The information providing device according to claim 1, wherein
the text data acquirer comprises a voice/text converter configured to recognize the obtained voice data and convert the voice data into the text data in the preset language.

3. The information providing device according to claim 1, wherein
the text data acquirer obtains the text data converted from the voice data via a signal line.

4. The information providing device according to claim 1, further comprising:
a text data storage configured to store the converted text data as file data in a readable manner.

5. The information providing device according to claim 1, wherein
the text data acquirer obtains a text in a different language from the preset language corresponding to the speech in form of text data, based on the voice data obtained by the voice data acquirer.

6. The information providing device according to claim 1, wherein
when an object placed in the predetermined area is changed,
the image combiner recognizes the change of the object based on the image data and, once recognizing the change, refrains from combining the text data corresponding to the voice data obtained before the change with image data representing an image of the object taken after the change.

7. The information providing device according to claim 1, wherein
when an object placed in the predetermined area is changed,
the image combiner recognizes the change of the object based on the image data and, once recognizing the change, uses still image data representing a latest still image of the object taken immediately before the change for image combining with the text data corresponding to the voice data obtained before the change for a predetermined time period to generate the composite image data.

8. The information providing device according to claim 1, wherein
the image combiner detects a blank area of the taken image based on the image data and generates composite image data representing a composite image including the text superimposed on the detected blank area of the taken image.

9. The information providing device according to claim 1, wherein
the text data acquirer comprises a text data acquisition changeover module configured to change over setting between acquisition or no acquisition of the text data in response to a user's preset operation, and
when the text data acquirer is set to no acquisition of the text data by the text data acquisition changeover module, the output unit outputs the image data, in place of the composite image data.

10. The information providing device according to claim 1, wherein
the image combiner comprises a text display controller configured to control at least one of size of the text to be combined to generate the composite image, font, number of characters on each line, number of lines in the text, color of characters, background color and display time, in response to a user's preset operation.

11. The information providing device according to claim 1, further comprising:
a word information acquirer configured to obtain information on a word included in the text in a displayable manner via a network, based on the text data representing the text obtained by the text data acquirer.

12. The information providing device according to claim 1, further comprising:
a correlated data storage configured to store the image data correlated to the text data in a readable manner.

13. A method of providing an image of a material, comprising:
taking an image of a predetermined area with a video camera and obtaining the taken image in form of image data;
externally obtaining voice data representing speech via a microphone;
obtaining a text in a preset language corresponding to the speech in form of text data, based on the obtained voice data;
generating a composite image including the taken image and the text in form of composite image data, based on the image data and the text data; and
outputting the composite image data.

14. A program product for implementing a method of providing an image of a material by a computer, comprising:
a non-transitory recording medium; and
a program recorded in the recording medium in a computer readable manner,
the program comprising program codes arranged to cause the computer to
take an image of a predetermined area with a video camera and obtain the taken image in form of image data;
externally obtain voice data representing speech via a microphone;
obtain a text in a preset language corresponding to the speech in form of text data, based on the obtained voice data;
generate a composite image including the taken image and the text in form of composite image data, based on the image data and the text data, and output the composite image data.
